(19) United States
(12) Patent Application Publication
(10) Pub. No.: US 2009/0184218 A1
(43) Pub. Date: Jul. 23, 2009

(54) Portable ventilated inclined laptop stand

(76) Inventor: John Marshall Buckles, Albuquerque, NM (US)

Correspondence Address: John M. Buckles, 327 Granite N.E., Albuquerque, NM, 87102, US

(21) Appl. No.: 12/316,289

(22) Filed: Dec. 12, 2008

Related U.S. Application Data
(60) Provisional application No. 61/011,514, filed on Jan. 18, 2008.

(51) Int. Cl. F16M 11/22

(52) U.S. Cl. 248/176.1

(57) ABSTRACT

A portable, easily disassembled support platform for a laptop computer, having two identical inclined planes that interlock at a midpoint mortise joint, creating an interlocking X shaped support platform for laptop computers.

Both inclined planes being identical in shape and dimension, and having openings which serve as pathways for the removal of heat generated by the electrical components within laptop computers.

The use of a mortise joint at midpoint allows the device to be easily disassembled and transported in most laptop carrying cases.

### 1. CROSS-REFERENCE TO RELATED APPLICATIONS

Not Applicable

### 2. STATEMENT REGARDING FEDERALLY SPONSORED RESEARCH OR DEVELOPMENT

### 3. REFERENCE TO SEQUENCE LISTING, A TABLE OR A COMPUTER PROGRAM LISTING COMPACT DISK APPENDIX

Not Applicable

### 4. BACKGROUND OF THE INVENTION

The field of endeavor of this invention is a laptop computer enhancing accessory.
1. The flat typing plane of most laptop computers is in some cases detrimental to typing efficiency and ergonomically incorrect.
2. Heat accumulation is undesirable and detrimental to laptop computers.
3. The existing accessories for dealing with heat accumulation and keyboard angle are not readily portable, in that they are not easily fitted into most carrying cases.

### 5. BRIEF SUMMARY OF THE INVENTION

1. This invention by elevating the rearward most portion of any laptop computer creates an angle to the laptop keyboard, making for a more comfortable typing experience.
2. This invention by providing a ventilated platform for laptop computers addresses the problem of heat accumulation.
3. This invention by being designed to fit into most laptop carrying cases, and being readily and easily dissembled addresses the problem of portability.

### BRIEF DESCRIPTION OF THE SEVERAL VIEWS OF THE DRAWING

FIG. 1 depicts components of the device.

FIG. 1a depicts a keyboard stop. The purpose of which is to prevent the laptop from sliding down the inclined surface of the device.

FIG. 1b depicts the mortises. The purpose of which are to provide a means of assembling both pieces of the device together to form an X shaped platform for the support of a laptop computer.

FIG. 1c depicts heat openings. The purpose of which are to provide escape pathways for the heat generated by the components within laptop computers.

FIG. 2 depicts an unassembled device.

FIG. 3 depicts a device in use.

FIG. 4 depicts a front page view.

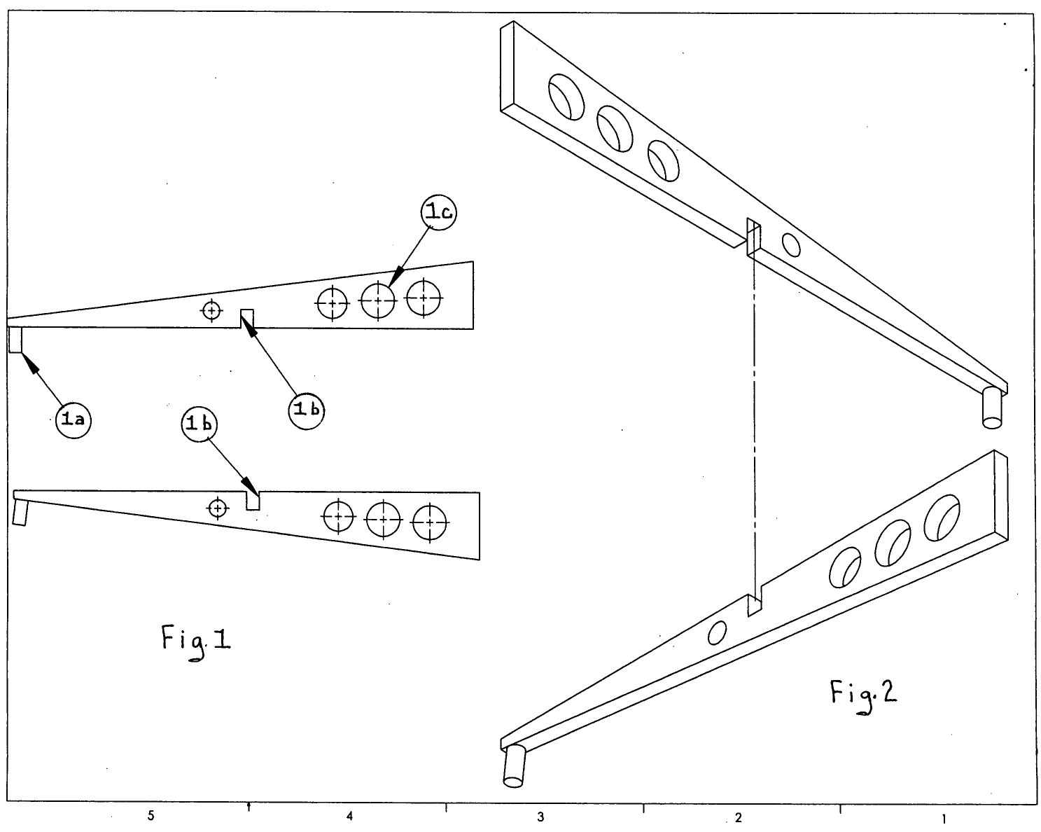

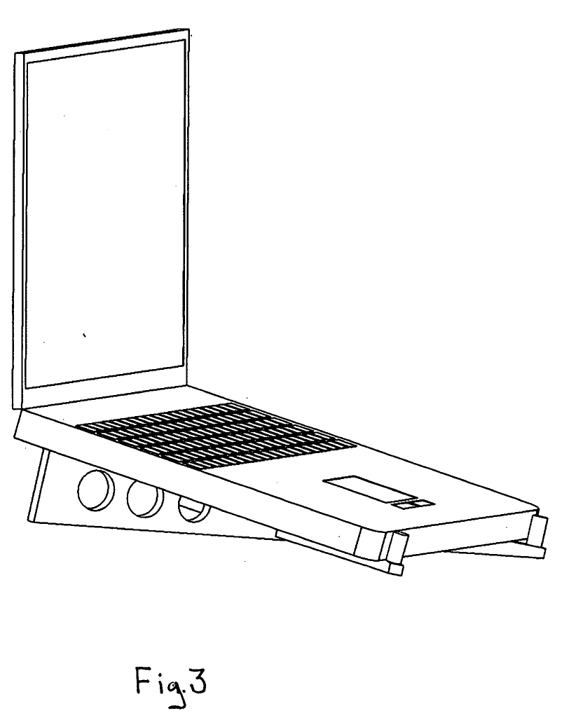

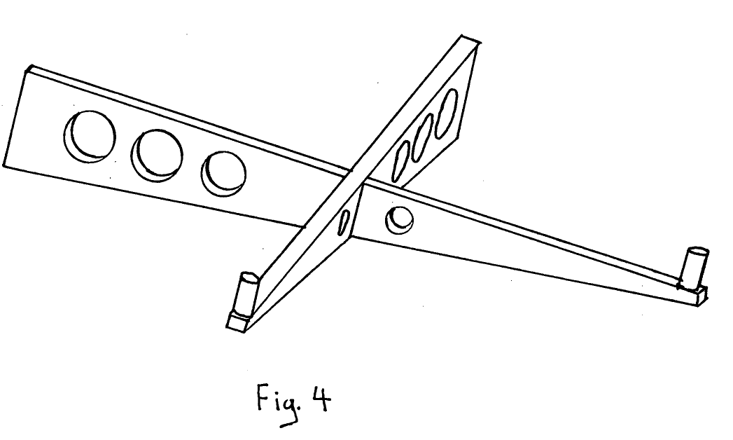

### DETAILED DESCRIPTION OF THE INVENTION

Portable ventilated inclined laptop stand. 01 A portable inclined laptop computer stand consisting of two identical parts which can be easily assembled for use, and dissembled for transport or storage. 02 The making of which is as follows. A flat section of wood or other suitable material rectangular in shape and approximately dimensioned 2½ to 3 in.×⅜ in.×14 in. is cut in the diagonal forming two equal and identical inclined planes. At midpoint on either long edge of both planes a mortise is cut in the vertical to a depth halfway down in both inclined planes, the width of which shall be the thickness of the material being used (in this case ⅜ in.) A series of openings, holes are drilled on both flat surfaces of the inclined planes to provide pathways for the venting of heat. At the front (pointed end) of both inclined planes a short post is attached which will serve as a rest or stop for the front edge of laptop keyboard to prevent laptop from sliding down in use. Both identical halves of inclined planes can also be made by the plastic injection molding process. 03 To use this device both inclined planes are brought together and joined at Mortise cut, forming an interlocking X. Devise is placed on flat surface, table top, desktop etc. in a flat position so that short posts are in an upright position and towards the operator. Laptop is now placed on the platform created by the interlocking of both inclined planes, which have now formed an X shaped platform. Front edge of laptop keyboard is allowed to rest or stop at vertical posts to prevent the sliding down of laptop computer, which is now at a slightly downward slopping angle. 04 The distinguishing points of this invention from other I have observed are that the problem of heat accumulation is addressed with no moving parts or other generating components, along with an angled keyboard, and being easily disassembled for transport or storage.

What is claimed is:

1. A portable laptop computer stand comprising:
a first member and an identical second member to be joined with said first member, wherein said first member and said identical second member when joined together comprise support platform adapted to receive a laptop computer at an inclined angle.

2. A portable laptop computer stand according to claim 1, wherein said first member and identical second member are of an inclined geometric shape.

3. A portable laptop computer stand according to claim 1, wherein said member and identical second member have within them openings, providing heat escape pathways.

4. A portable laptop computer stand according to claim 1, wherein said first Member and identical second member have within them at a point midway along the long edge of both inclined planes a mortise, for the purpose of interlocking first member and second member together, forming an interlockling X shaped platform for the support of a laptop computer.

5. A portable laptop computer stand according to claim 1, wherein said first member and identical second member have within them vertical posts serving as stops for laptop computers.

6. A portable laptop stand according to claim 1, wherein said first member and identical second member are constructed of wood.

7. A portable laptop computer stand according to claim 1, wherein said first member and identical second member are constructed of hard plastic.

8. A portable laptop stand according to claim 1, wherein said first member and identical second member are constructed of soft plastic.
